(19) United States
(12) Patent Application Publication
(10) Pub. No.: US 2007/0176016 A1
(43) Pub. Date: Aug. 2, 2007

(54) Sprinkler station expander

(76) Inventors: Kenneth I. Green, San Clemente, CA (US); Joseph D. Thinn, Costa Mesa, CA (US); Jan B. Wensink, Lake Elsinore, CA (US)

Correspondence Address: Kenneth L. Green, 8244 Painter Ave., Whittier, CA, 90602, US

(21) Appl. No.: 11/345,152

(22) Filed: Feb. 1, 2006

(51) Int. Cl. A01G 27/00

(52) U.S. Cl. 239/70

(57) ABSTRACT

A switch provides a sprinkler valve signal to a first sprinkler valve, and after a period of time, diverts the sprinkler valve signal to a second sprinkler valve. The switch is serially wired into sprinkler wires running between a timer and at least two sprinkler valves, and operates off the sprinkler valve signal present in the sprinkler wires. When the sprinkler valve signal comes on, the switch provides the sprinkler valve signal to the first sprinkler valve and starts a clock which counts for a period of time T. When the period of time T passes, the clock switches a relay which switches the sprinkler valve signal to the second sprinkler valve.

### BACKGROUND OF THE INVENTION

The present invention relates to adding sprinkler valves to a sprinkler system, and in particular to a timer which switches between sprinkler valves after a period of time.

Automatic sprinkler systems are commonly used to provide water to lawns, planters, and trees. The systems generally include at least one timer, sprinkler valves, and sprinklers. Timers control a fixed number of stations (i.e. sprinkler valves) and the timers may be programmed to some degree to control when and how long the sprinkler valves are turned on. Common timers have four to twelve stations.

In some cases the user may wish to add a new station, and the total may exceed the number of stations the timer can control. In this case, the user may be required to purchase a new timer. In other cases, a sprinkler wire buried under a lawn, plants, or concrete, may break, and the use of an existing sprinkler valve may be lost.

Circuits are known for adding a second sprinkler valve to stations, for example, U.S. Pat. No. 6,126,141 for “Irrigation system valve controller expansion apparatus.” The 141 patent describes a circuit which switches from a first sprinkler valve to a second sprinkler valve when a sprinkler valve signal from the timer is interrupted. Unfortunately, the use of such a switch requires a new or modified timer.

Therefore, a need remains for an apparatus and method for easily adding a sprinkler valve, or reconnecting a sprinkler valve when a wire breaks.

### BRIEF SUMMARY OF THE INVENTION

The present invention addresses the above and other needs by providing a switch which provides a sprinkler valve signal to a first sprinkler valve, and after a period of time, diverts the sprinkler valve signal to a second sprinkler valve. The switch is serially wired into sprinkler wires running between a timer and at least two sprinkler valves, and operates off the sprinkler valve signal present in the sprinkler wires. When the sprinkler valve signal comes on, the switch provides the sprinkler valve signal to the first sprinkler valve and starts a clock which counts for a period of time. When the period of time passes, the clock switches a relay which switches the sprinkler valve signal to the second sprinkler valve.

In accordance with one aspect of the invention, there is provided a sprinkler system comprising a timer adapted to generate a sprinkler valve signal, and a switch serially electrically connected between the timer and a sprinkler valve. The switch comprises a clock adapted to be powered by the sprinkler valve signal from the timer and to count to a period of time T, and a relay controllable by the clock. The relay is electrically connected to the clock and adapted to be activated at the end of the period of time T. The sprinkler valve is electrically connected to a normally closed terminal of the relay. A first sprinkler line is adapted to receive a flow of water from a water line until the relay is activated and a second sprinkler line adapted to receive a flow of water from the water line after the relay is activated while the sprinkler valve signal remains present.

In accordance with another aspect of the invention, there is provided a method for expanding a sprinkler system. The method includes the steps of electrically connecting a switch between a timer and both a first sprinkler valve and a second sprinkler valve, providing a sprinkler valve signal to the switch, providing the sprinkler valve signal to a clock in the switch, count a period of time within the clock when the sprinkler valve signal is present, sending a clock signal from the clock to a relay when the period of time has ended, and switching an output sprinkler valve signal from the first sprinkler valve to the second sprinkler valve when the relay receives the clock signal. The sprinkler signal may further be conditioned by a rectifier before being provided to the clock or the clock may be an Alternating Current (AC) clock. Adjustment of the switch (or time period) may be accomplished by adjusting a resistance connected to the clock.

In accordance with yet another aspect of the invention, there is provided a second method for expanding a sprinkler system. The method includes the steps of electrically connecting a switch between a timer and a sprinkler valve, providing a sprinkler valve signal to the switch, providing the sprinkler valve signal to a first clock in the switch, counting a first period of time T1 within the first clock when the sprinkler valve signal is present, sending a clock signal from the first clock to a first relay when the first period of time T1 has ended, actuating the first relay, thereby opening a normally closed circuit between the first relay and the sprinkler valve, and closing a normally open circuit between the first relay and a second clock, counting a second period of time T2 within the second clock when the first relay is activated, sending a second clock signal from the second clock to a second relay when the second period of time T2 has ended, actuating the second relay, thereby closing a normally open circuit between the second relay and the sprinkler valve, interrupting a flow of water from the sprinkler valve to a sequential valve, and sequencing the flow of water from a first sprinkler line to a second sprinkler line.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a prior art sprinkler system including a timer controlling two sprinkler valves.

FIG. 2 is a sprinkler system with a switch according to the present invention connected between the timer and both sprinkler valves after a wire has broken.

FIG. 2A is a sprinkler system having a second switch according to the present invention and a sequential sprinkler valve.

FIG. 3 is a functional diagram of the switch.

FIG. 3A is a functional diagram of the clock included in the switch.

FIG. 3B is a diagram of a variable resistance connected to the clock.

FIG. 4 is a circuit diagram of the switch.

FIG. 5 is a second switch according to the present invention including an AC clock.

FIG. 6 is a circuit diagram of the second switch.

FIG. 7 is a third switch according to the present invention.

FIG. 8 is a circuit diagram of the third switch.

FIG. 9 describes a first method for expanding a sprinkler system according to the present invention.

FIG. 10 describes a second method for expanding a sprinkler system according to the present invention.

FIG. 11 is a side view of a sequential valve according to the present invention.

FIG. 11A is a cross-sectional view of a valve body of the sequential valve taken along line 11A-1A of FIG. 11.

FIG. 12 is a gate of the sequential valve.

FIG. 12A is a cross-sectional view of the gate taken along line 12A-12A of FIG. 12.

FIG. 13 is a piston of the sequential valve.

FIG. 14 is a perspective cross-sectional view of a valve body of the sequential valve taken along line 11A-1A of FIG. 11.

FIG. 15A is a cut away view of the sequential valve in an OFF position.

FIG. 15B is a cut away view of the sequential valve in an ON position.

FIG. 15C is a cut away view of the sequential valve just after a flow of water through the valve had been turned off.

FIG. 15D is a second cut away view of the sequential valve in an ON position showing a flow of water through the valve.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

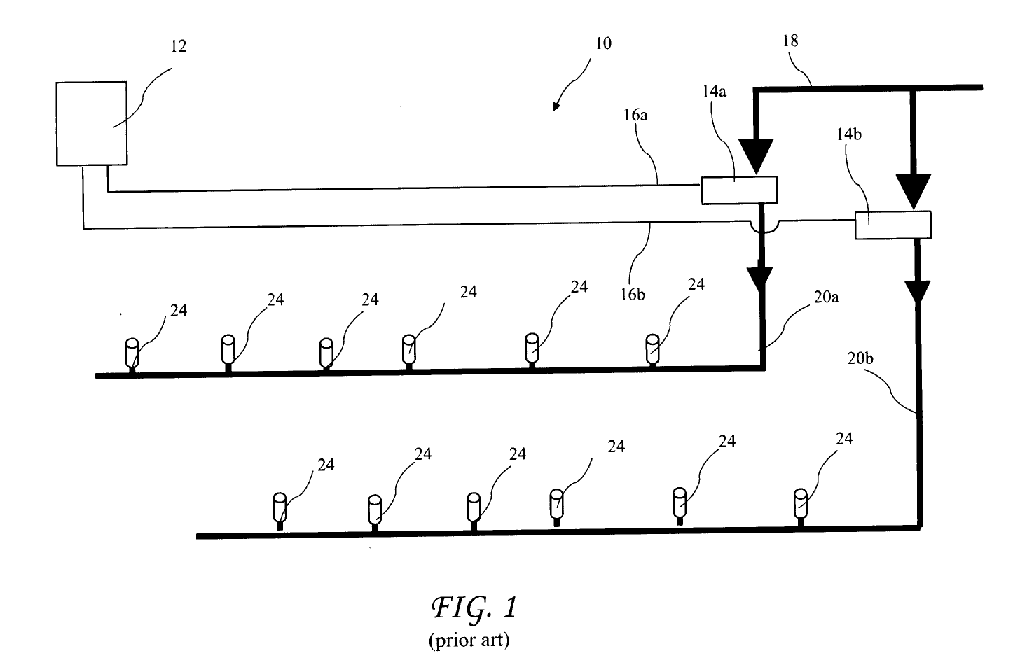

The present invention provides a simple and effective system for expanding a sprinkler system. A prior art sprinkler system 10 including a timer 12 controlling two sprinkler valves 14a, 14b is shown in FIG. 1. Sprinkler wires 16a, 16b, electrically connect the timer 12 to the sprinkler valves 14a, 14b. The sprinkler valves control a flow of water from a water line 18 to sprinkler lines 20a, 20b, and thereby controls the flow of water to sprinklers 24.

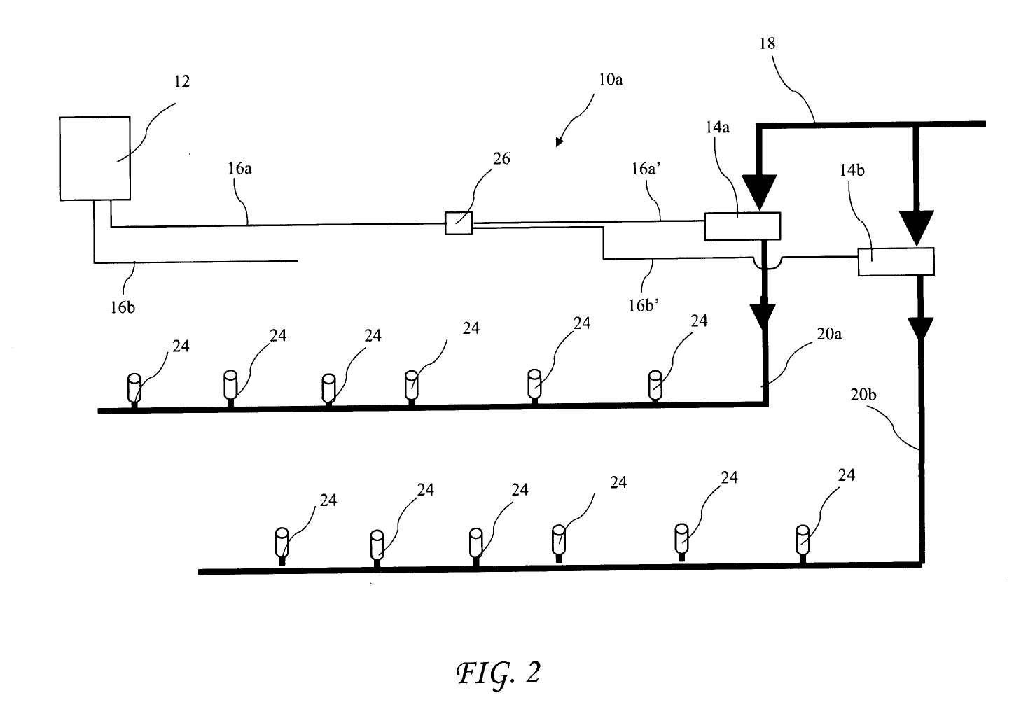

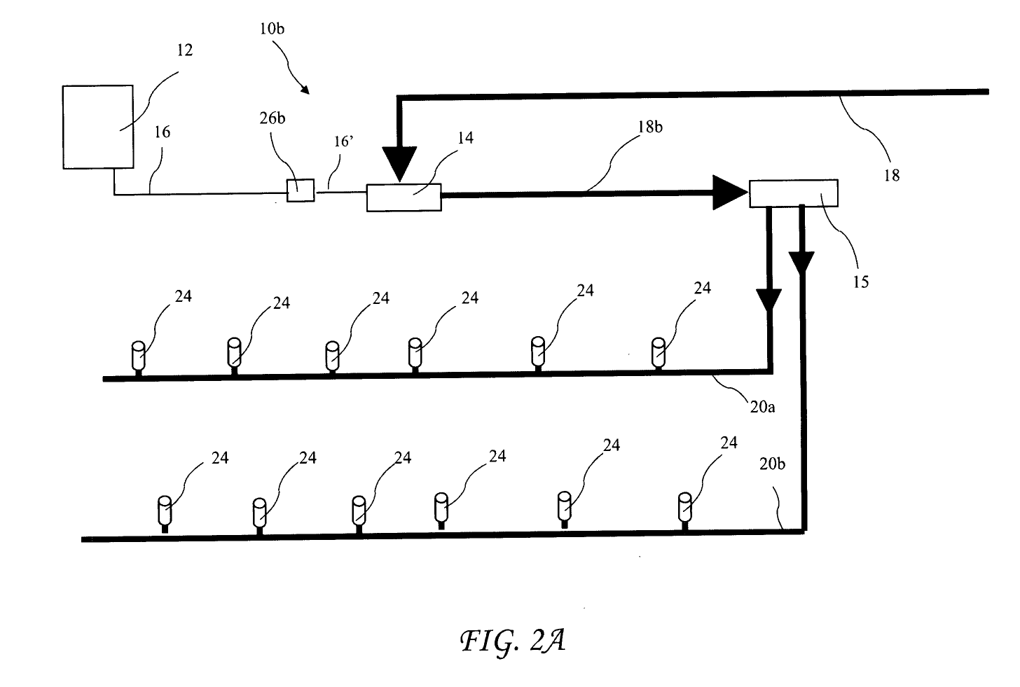

An improved sprinkler system 10a with a first switch 26 according to the present invention connected between the timer 12 and sprinkler valves 14a, 14b after a sprinkler wire 16b wire has broken is shown in FIG. 2. The sprinkler wire 16a is connected as an input to the switch 26. The switch 26 is then connected by sprinkler wire 16a′ and 16b′ to the sprinkler valves 14a, 14b. When a sprinkler valve signal is present on the sprinkler wires 16a, the switch 26 provides the sprinkler valve signal to the sprinkler valve 14a for a period of time T, and then switches the sprinkler valve signal to the sprinkler valve 14b.

A second embodiment of the present invention is sprinkler system 10b shown in FIG. 2A. The sprinkler system 10b includes a second switch 26b which interrupts a sprinkler signal sent from the timer 12 to a sprinkler valve 14. The sprinkler wire 16 carries the sprinkler valve signal from the timer 12 to the switch 26b, and a second sprinkler wire 16′ carries an interrupted sprinkler valve signal from the switch 26b to the sprinkler valve 14. The interrupted sprinkler valve signal causes the sprinkler valve 14 to interrupt a flow of water from the water line 18 to a second water line 18b connected to a sequential valve 15. The sequential valve 15 connects the flow of water from the water line 18b to the first sprinkler line 20a before the interruption and then to the second sprinkler line 20b after the interruption. As a result, a single water line may provide water to two set of remote sprinklers through a single water line 18 without running sprinkler wires to the remote sprinkler valves.

Sequential valves of various types are described in U.S. Pat. No. 6,622,933, U.S. Pat. No. 4,632,361, U.S. Pat. No. 4,407,451, U.S. Pat. No. 4,116,216, U.S. Pat. No. 3,853,145, and U.S. Pat. No. 3,027,094. The '933, '361, 451, '216, '145, and '094 patents are herein incorporated by reference.

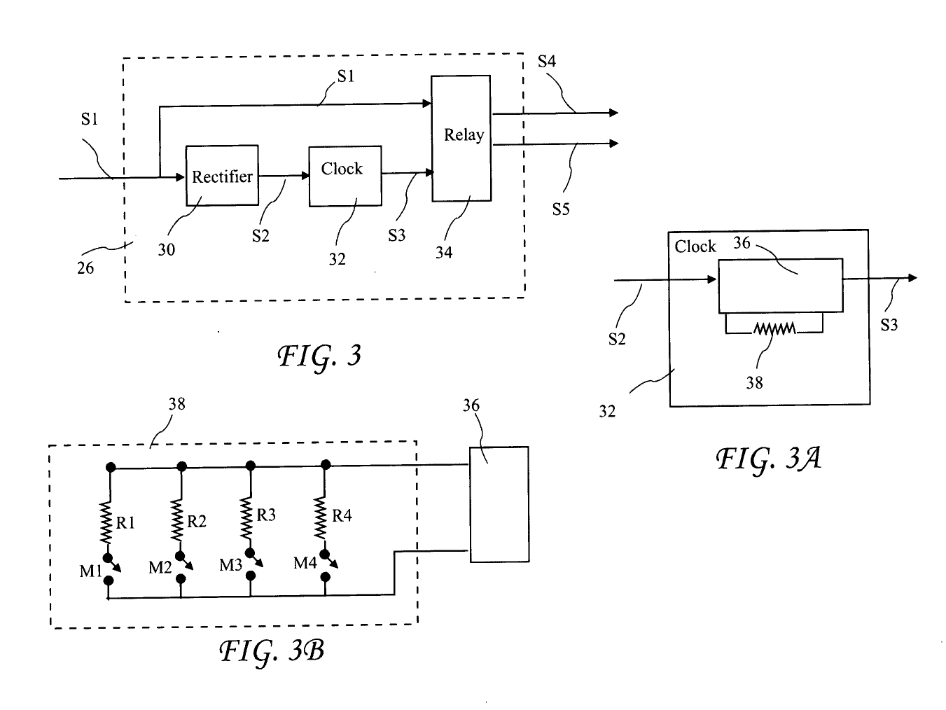

A functional diagram of the switch 26 is shown in FIG. 3. The switch 26 includes a rectifier 30, a clock 32, and a relay 34. A signal S1, preferably a sprinkler valve signal, and more preferably a 24 Volt Alternating Current (VAC) sprinkler valve signal, is provided to the rectifier 30 and to the relay 34. The rectifier 30 processes the signal S1 and generates a rectified signal S2 which is provided to the clock 32. The clock 32 comes on when the rectified signal S2 is present, and counts for a period of time T. When the signal S2 has been present for the period T, the clock 32 sends a clock signal S3 to the relay 34. The relay 34 initially connects the signal S1 to the output S4. When the relay 34 is activated, the relay 34 connects the signal S1 to the output S5.

A functional diagram of the clock 32 included in the switch 26 is shown in FIG. 3A. The clock preferably comprises a delay timer 36 with a resistor 38 electrically connected to determine the period T. The resistor 38 is preferably a variable resistor, for example, a potentiometer and/or a plurality of selectable resistors. An example of selectable resistors in shown in FIG. 3B. Four resistors R1, R2, R3, and R4 are connected to the delay timer 36 in parallel through four switches M1, M2, M3, and M4. In a first position, the resistor R1-R4 are out of the circuit. In a plurality of second switch positions, each of the resistors R1-R4 is connected in parallel into the circuit. By selectively switching each switch M1-M4, the total resistance may be set. The resistance 38 is preferably variable to provide a period T between one minute and 60 minutes. Other methods of selecting the period T may be used, and any switch serially connected between a sprinkler timer and two or more sprinkler valves, the switch having a clock to switch a relay, is intended to come within the scope of the present invention.

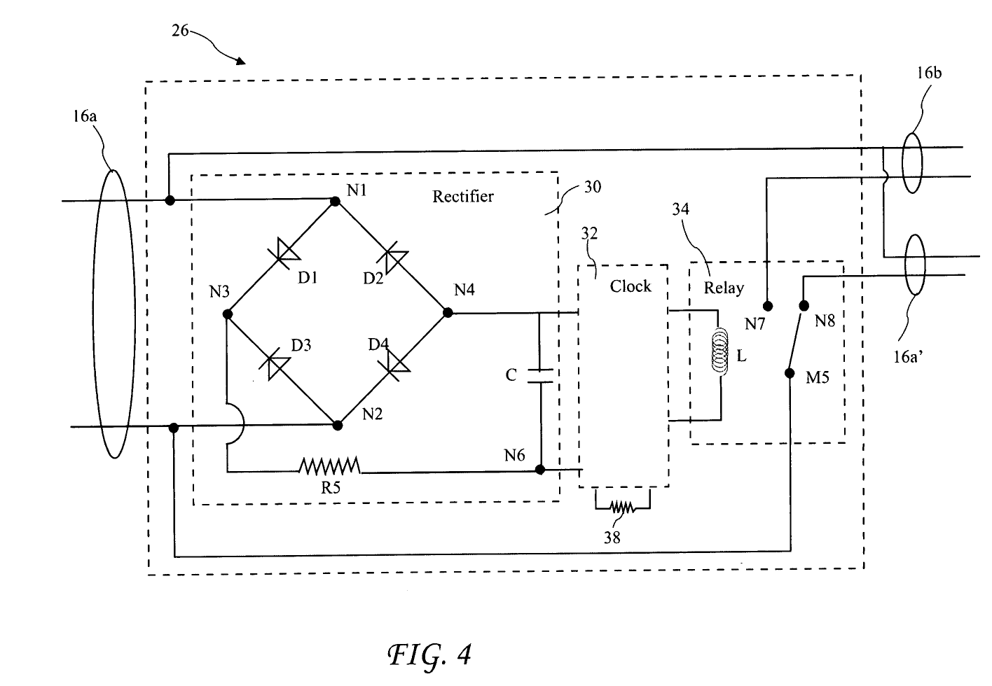

A circuit diagram of the switch 26 is shown in FIG. 4. Sprinkler wire 16a is connected to nodes N1 and N2 of a rectifier comprising diodes D1, D2, D3, and D4. Node N4 is connected to the clock 32 and node N3 is connected to the clock 32 through a resistor R5 and node N6. A capacitor C is connected between the Node N4 and Node N6. The clock 32 is connected to a coil L in the relay 34, and a switch M5 in the relay 34 switchedly connects the sprinkler wire 16a to sprinkler wire 16a′ or 16b. First output leads (or wires) 16a′ are connected to a normally closed terminal at node N8, and second output leads (or wires) 16b are connected to a normally open terminal at node N7. Both outputs include a common wire which may be two separate common wires, or a shared common wire. The capacitor C and the resistor R5 filter the output of the rectifier 30 to provide a smoother signal to the clock 32.

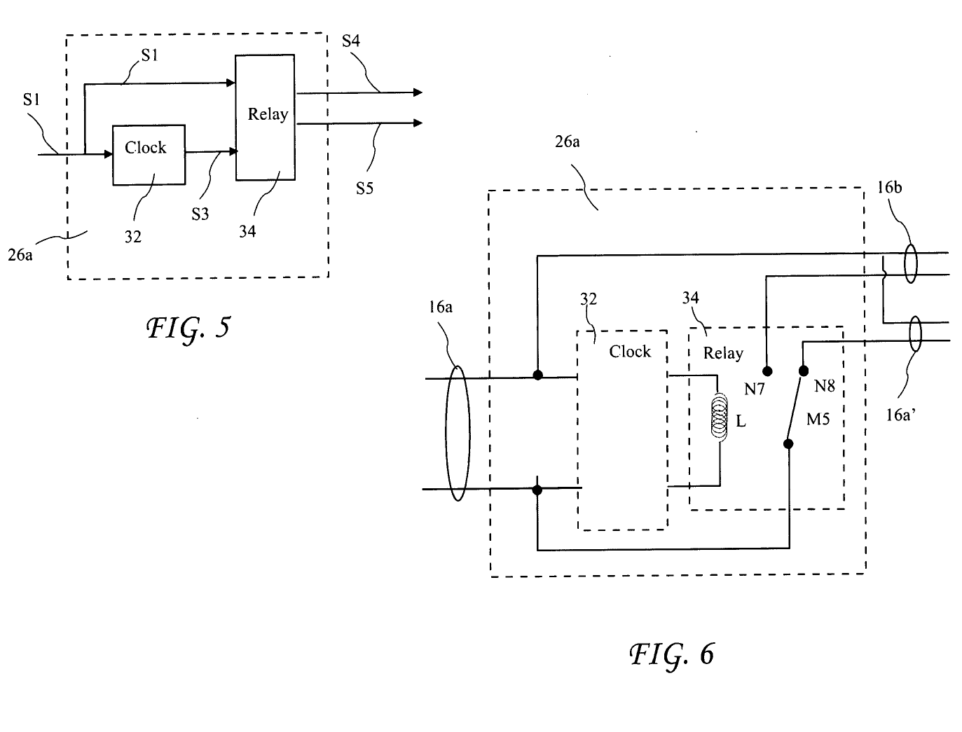

A functional diagram of the second switch 26a is shown in FIG. 5. The switch 26a includes a clock 32 which is an Alternating Current (AC) clock, and a relay 34 which is an AC relay, thereby eliminating the need for a rectifier. The AC clock is preferably an AC delay-on-make timer, for example, a KH142 made by ICS, Inc. in Addison, Ill. A circuit diagram of the switch 26a is shown in FIG. 6, which circuit is similar to the circuit in FIG. 4, with the rectifier and filtering elements removed.

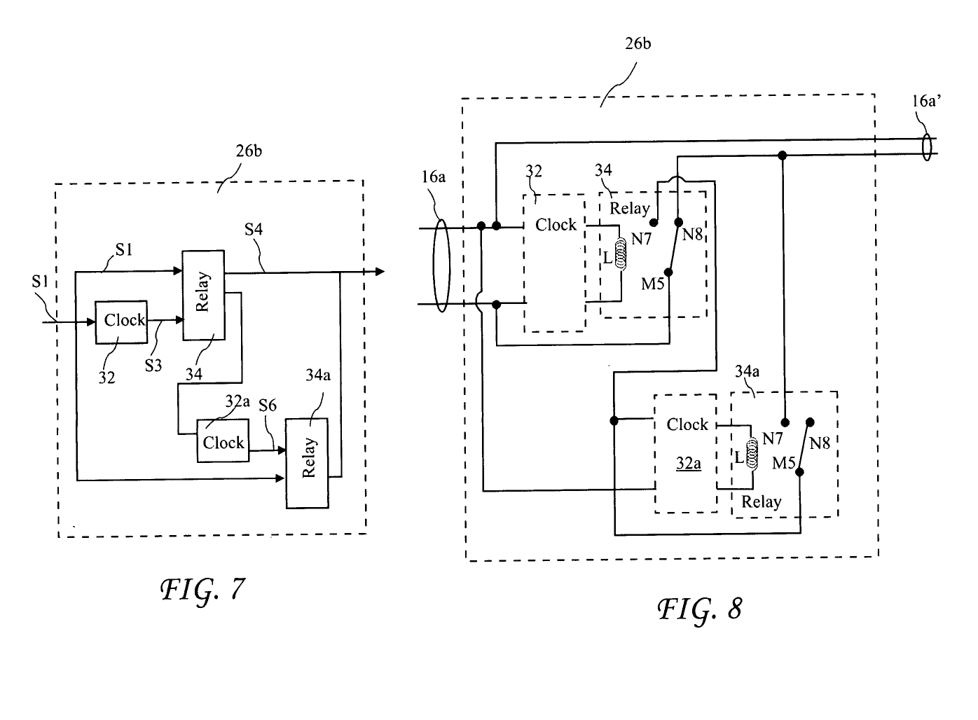

A functional diagram of the third switch 26b is shown in FIG. 7. The switch 26b has a single sprinkler valve output, and interrupts the sprinkler valve signal, versus switching between two sprinkler valves. The clock 32 is connected to the relay 34 as in the switch 26. In this instance, however, the relay 34 is connected to a second clock 32a instead of a second sprinkler valve. The second clock 32a is connected to a second relay 34a, and the second relay 34a is connected to the first sprinkler valve.

A circuit diagram of the switch 26b is shown in FIG. 8. The normally closed terminal of the relay 34 at node N8 is connected to the sprinkler wires 16a′, whereby the sprinkler valve signal is provided to the sprinkler wires 16a′ as long as the sprinkler valve signal is being provided to the relay 34, and the relay 34 has not been activated. When the relay 34 is activated, the sprinkler valve signal is disconnected from the sprinkler wire 16a′, and is provided to the second clock 32a through the normally open terminal at node N7.

When the clock 32a receives power, the clock 32a counts a second period of time T2. At the end of the period of time T2, the clock 32a activates the relay 34a. When the relay 34a is activated, the sprinkler valve signal is again provided to the sprinkler wires 16a′. Thus, the sprinkler valve signal is present on the sprinkler wires 16a′ between the switch 26b and a sprinkler valve for a period of time T1, then the sprinkler valve signal is disconnected for the period of time T2, and then the sprinkler valve signal is again provided to the sprinkler wire 16a′. Thus an interruption in the sprinkler valve signal is generated, that results in an interruption in the flow of water to the sequential valve 15 (see FIG. 2A), and results in the flow of water ending in the sprinkler line 20a, and starting in the sprinkler line 20b.

The switch 26b may use an AC clock and AC relay, operating directly on an AC sprinkler valve signal, or the switch 26b may include a rectifier 30 (see FIGS. 3 and 4) to process the AC signal.

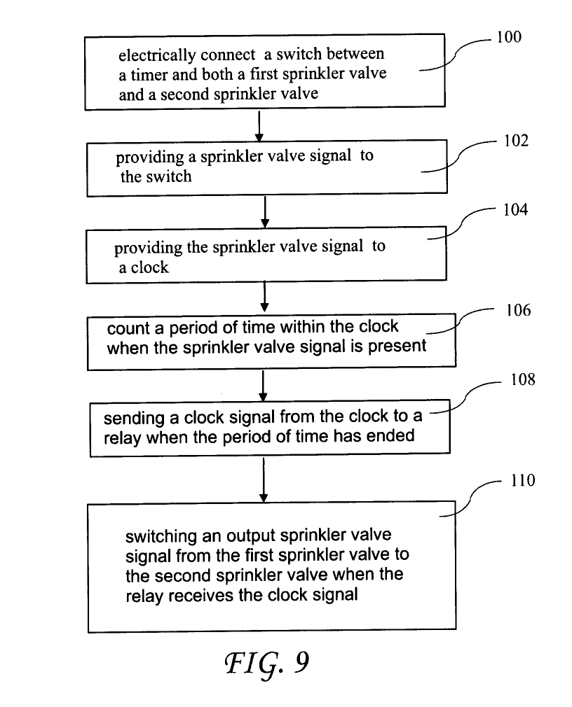

A method for expanding a sprinkler system according to the present invention is described in FIG. 9. The method includes the steps of electrically connecting a switch between a timer and both a first sprinkler valve and a second sprinkler valve at step 100, providing a sprinkler valve signal to the switch at step 102, providing the sprinkler valve signal to a clock in the switch at step 104, counting a period of time within the clock when the sprinkler valve signal is present at step 106, sending a clock signal from the clock to a relay when the period of time has ended at step 108, and switching an output sprinkler valve signal from the first sprinkler valve to the second sprinkler valve when the relay receives the clock signal at step 110. The sprinkler signal may further be conditioned by a rectifier before being provided to the clock. Adjustment of the switch may be accomplished by adjusting a resistance connected to the clock.

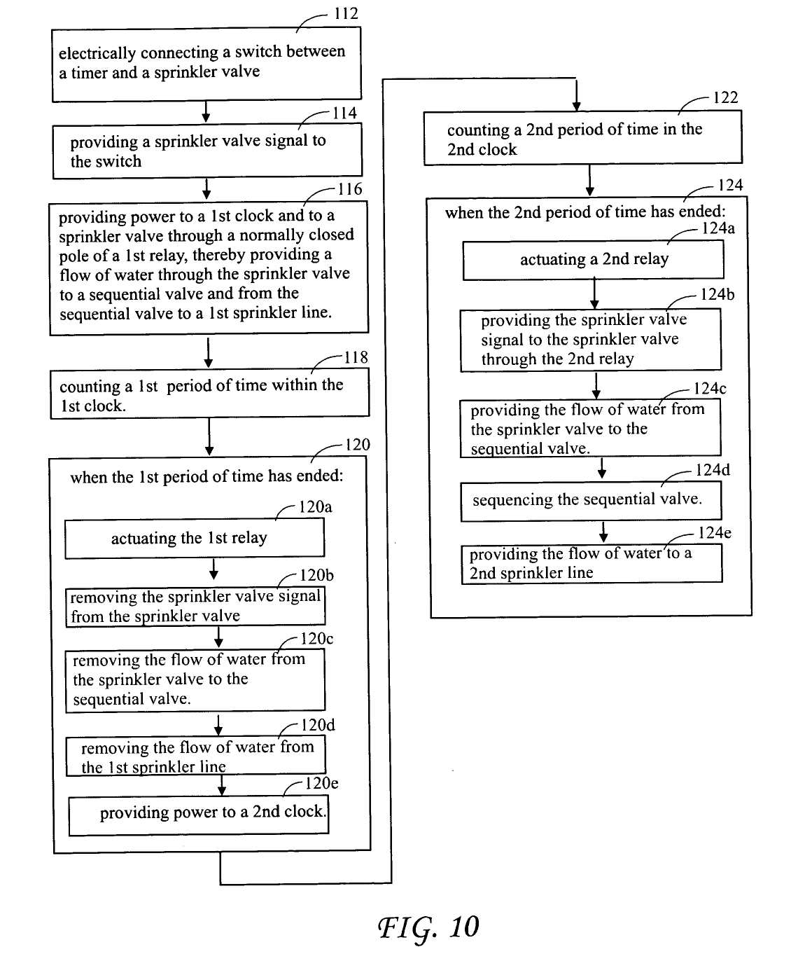

A second method according to the present invention is described in FIG. 10. The second method comprises electrically connecting a switch between a timer and a sprinkler valve at step 112, providing a sprinkler valve signal to the switch at step 114, providing power to a 1st clock and to a sprinkler valve through a normally closed pole of a 1st relay, thereby providing a flow of water through the sprinkler valve to a sequential valve and from the sequential valve to a 1st sprinkler line at step 116, counting a first period of time T1 within the first clock when the sprinkler valve signal is present at step 118, when the 1st period of time has ended: removing the flow of water from the 1st sprinkler line and providing power to a second clock at step 120, counting a second period of time T2 in the second clock at step 122, and when the second period of time has ended, providing the flow of water to a second sprinkler line at step 124.

The step 120 of removing the flow of water from the first sprinkler line and providing power to a second clock preferably comprises actuating the first relay at step 120a, removing the sprinkler valve signal from the sprinkler valve at step 120b, removing the flow of water from the sprinkler valve to the sequential valve at step 120c, removing the flow of water from the first sprinkler line at step 120d, and providing power to a 2nd clock at step 120e. The step 124 of when the second period of time has ended, providing the flow of water to a second sprinkler line, preferably comprises actuating a second relay at step 124a, providing the sprinkler valve signal to the sprinkler valve through the second relay at step 124b, providing the flow of water from the sprinkler valve to the sequential valve at step 124c, sequencing the sequential valve at step 124d, and providing the flow of water to a second sprinkler line at step 124e.

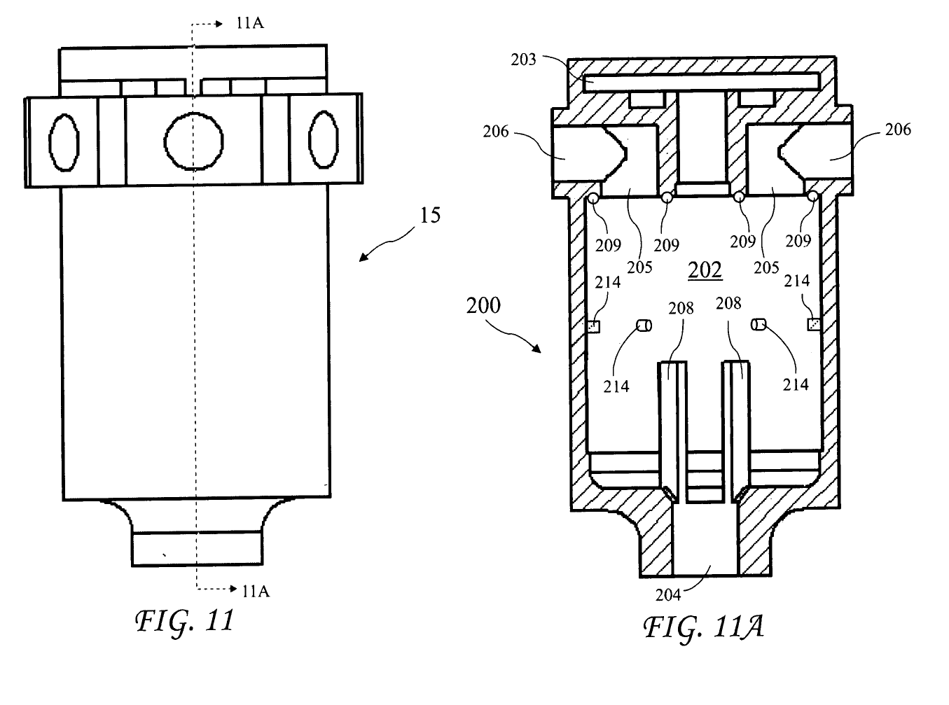

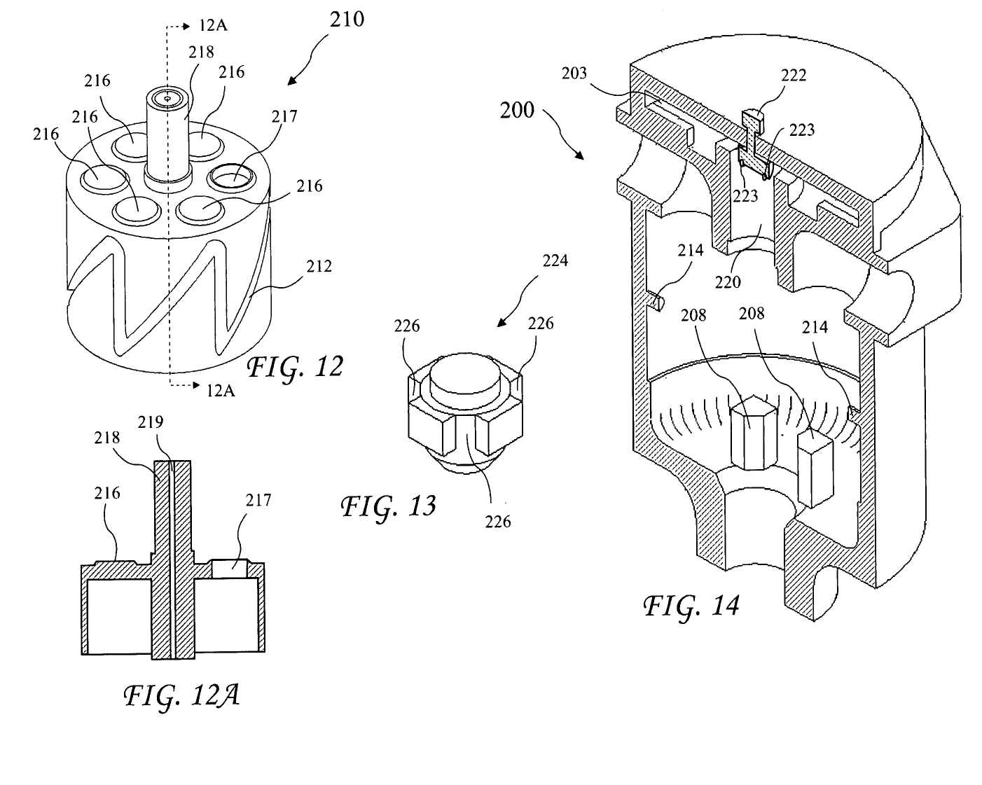

A side view of the sequential valve 15 according to the present invention is shown in FIG. 11, and a cross-sectional view of a valve body 200 of the sequential valve 15 taken along line 11A-11A of FIG. 11 is shown in FIG. 11A. The preferred sequential valve 15 is a combination of a sequential valve and a vacuum brake. The valve 15 thus provides two functions in a compact apparatus reducing cost and labor for installation of the valve 15. The valve body 200 includes an interior 202. An inlet 204 allows water to enter the interior 202, and outlets 206 allow water to leave the interior 202. Water passes out of the interior 202 through outlet mouths 205. Mouth seals 209 reside around the mouths 205 to seal with the gate plugs 216 and the gate outlet 217 (see FIG. 12) when the gate 210 is pushed against the mouths 205. A venting passage 203 is in fluid cooperation with the interior 202 and with the exterior of the valve 15, and as explained later, provides the vacuum brake function. Piston guides 208 reside in the interior 202 to guide the piston 224 (see FIGS. 13, 15, and 16). Gate guides 214 reside in the interior 202 to guide the gate 210 (see FIGS. 12, 15, 16).

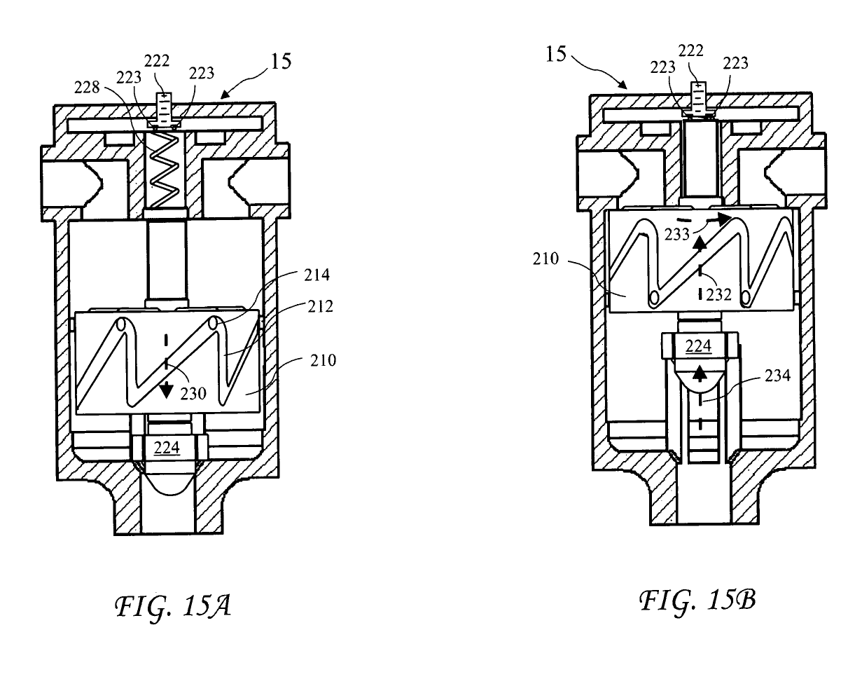

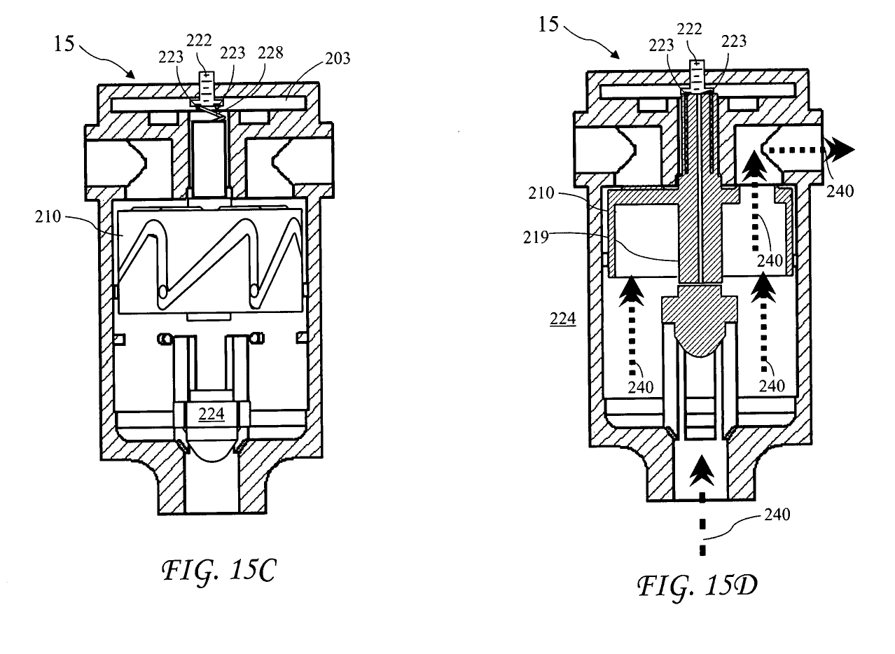

The gate 210 of the valve 15 is shown in a perspective view in FIG. 12. The gate 210 includes a cylindrical body with a sawtooth groove 212 on the exterior. The groove 212 cooperates with the gate guides 214 to cause the gate 210 to move diagonally upward when sufficient water flow enters the inlet 204, and to move vertically downward when the water flow is removed from the inlet 204 of the valve 15. A gate spring 228 (see FIG. 15A) provides downward force on the gate 210 to move the gate downwards when the water flow is removed from the inlet 204. The gate 210 also includes a multiplicity of plugs 216 for engaging the outlet mouths 205. The plugs 216 are spaced to align with the outlet mouths 205 preferably to help index the gate 210, and a gate outlet 217 is provided to align with one of the outlet mouths 205 to provide a flow of water out of the valve 15. A gate nose 218 extends upward from the gate 210.

A cross-sectional view of the gate 210 taken along line 12A-12A of FIG. 12 is shown in FIG. 12A. The gate 210 includes a gate vent 219 extending vertically through the gate 210. The gate vent 219 allow water trapped in the valve 15 to escape after the water supply to the valve 15 is removed and the piston 224 drops blocking the inlet 204 (see FIG. 11A).

The piston 224 of the sequential valvel5 is shown in FIG. 13. The piston 224 includes piston notches 226 which cooperate with the piston guides 208 (see FIG. 11A) to guide the piston 224. When the flow of water is removed from the sequential valve 15, the piston 224 drops into the inlet 204, thus restricting a reverse flow of water from the sequential valve 15. The piston 224 is preferably a weighted piston to promote the falling of the piston 224 when a flow of water is removed, thus facilitating a vacuum break function of the valve 15.

A perspective cross-sectional view of a valve body 200 of the sequential valve 15 taken along line 11A-11A of FIG. 11 is shown in FIG. 14. The piston guides 208 and gate guides 214 are shown in the interior 202. A nose guide 220 cooperates with the gate nose 218 (see FIG. 12) to further guide the gate 210. An adjusting screw 222 resides at the top of the nose guide 220, allowing adjustment of a bleed-off rate of the sequential valve 15 and/or the seating of the gate 210 against the outlet mouths 205 (see FIG. 11A). The adjusting screw 222 includes a sealing portion inside the valve with seal 223. The seal 223 is preferably an O-Ring seal which seals against a top surface of the gate nose 218. The adjusting screw 222 preferably threadably engages the valve body 200, and turning the adjusting screw 222 advances the sealing portion toward the gate nose 218, and turning the adjusting screw 222 in the opposite direction draws the sealing portion away from the gate nose 218. The sealing portion may further include a seat for the gate spring 228.

A cut away view of the sequential valve 15 in an OFF (or gate 210 down) position is shown in FIG. 15A. The piston 224 and the gate 210 are both in down position along arrow 230. The spring 228 and/or gravity, bias the gate 210 and piston 224 into the down position.

A second cut away view in FIG. 15B shows the piston 224 and the gate 210 in the up or ON position. The piston 224 has moved vertically along arrow 234. The stationary gate guides 214 (see FIG. 11A) cooperate with the diagonally sloped portion of the sawtooth 212 (see FIG. 12) of the gate 210 resulting in a vertical translation 232 and a rotation 233 of the gate 210.

A third cut away view in FIG. 15C shows the piston 224 fallen to the down position just after the water flow into the inlet 204 has been removed, with the gate 210 remaining in the up or ON position. The piston 224 drops quickly to the down position because of the weight in the piston. The gate 210 may drop somewhat slower because water trapped in the interior of the valve 15 must bleed through the outlets 206 (see FIG. 11A) and/or the gate vent 219 (see FIG. 12A). As soon as the gate 210 drops slightly, either from weight, from water flowing back into the valve 15 through the outlet 206, and/or from the force of the gate spring 228, the gate vent 219 is open to venting passage 203 which is vented to the outside of the valve 15.

A cross-sectional view of the sequential valve 15 in an ON (or gate up) position showing a flow of water 240 through the valve 15 is shown in FIG. 15D. The gate outlet 217 (see FIG. 12) is shown aligned with one of the outlets 206 to direct the flow of water 240 through the sequential valve 15. When the gate 210 is in a fully ON position, the nose 218 engages the seal 223 to seal the gate 210 to the valve body 200.

The notch guides 214 cooperate with the notches 212 to diagonally translate (i.e, vertically translate and rotate) the gate 210 when the gate moves from the down position (see FIG. 15A) to the up position (see FIG. 15B). The notch guides 214 cooperate with the notches 212 to vertically translate the gate 210 when the gate moves from the up position (see FIG. 15B) top to the down position (see FIG. 15A). Thus each time the water is turned on, the gate moves vertically up and rotates to sequentially provide a flow of water to one of the outlets 206, and every time the water is turned off, the gate 210 moves down. The next time the water is turned on, the water will be directed to the next outlet 206.

When the water is turned off, any backflow in the water lines which enters the interior 202 will escape through the nose guide 220 (see FIG. 14 and the venting passage 203 (see FIG. 11A) to the exterior (i.e., atmosphere) thus providing the vacuum brake.

While the invention herein disclosed has been described by means of specific embodiments and applications thereof, numerous modifications and variations could be made thereto by those skilled in the art without departing from the scope of the invention set forth in the claims.

I claim:

1. A sprinkler system comprising:
a timer adapted to generate a sprinkler valve signal;
a switch serially electrically connected between the timer and a sprinkler valve, the switch comprising:
a clock adapted to be powered by the sprinkler valve signal from the timer and to count to a period of time T; and
a relay controllable by the clock, wherein the relay is electrically connected to the clock and adapted to be activated at the end of the period of time T, wherein the sprinkler valve is electrically connected to a normally closed terminal of the relay; and
a first sprinkler line adapted to receive a flow of water from a water line until the relay is activated; and
a second sprinkler line adapted to receive a flow of water from the water line after the relay is activated.

2. The sprinkler system of claim 1, further including a rectifier serially electrically connected between the timer and the clock, wherein the clock is a Direct Current (DC) clock adapted to receive DC power provided by the rectifier.

3. The sprinkler system of claim 1, wherein:
the sprinkler valve signal is an Alternating Current (AC) sprinkler valve signal, the timer is an AC timer, and the relay is an AC relay; and
the AC timer and the AC relay are adapted to be powered by the AC sprinkler valve signal.

4. The sprinkler system of claim 3, wherein the AC timer comprises an AC delay-on-make timer.

5. The sprinkler system of claim 1, wherein a resistance is electrically connected to the clock, and the resistance determines the length of the period of time T.

6. The sprinkler system of claim 5, wherein the resistance is a variable resistance which is changeable to change the length of the time period T.

7. The sprinkler system of claim 6, wherein the variable resistance is a potentiometer.

8. The switch of claim 6, wherein the variable resistance is a series of switchable resistors.

9. The sprinkler system of claim 1, wherein:
the sprinkler valve comprises a first sprinkler valve connected between the water line and the first sprinkler line; and
the sprinkler system further includes:
a second sprinkler valve connected between the water line and the second sprinkler line;
a first output wire electrically connected between the normally closed terminal of the relay and the first sprinkler valve;
a second output wire electrically connected between a normally open terminal of the relay and the second sprinkler valve; and
an output common wire electrically connected to both sprinkler valves.

10. The sprinkler system of claim 9, wherein the switch is attached to the first sprinkler valve.

11. The sprinkler system of claim 1, wherein:
the clock is a first clock, the relay is a first relay, and the period of time T is a first period of time T1;
the switch further includes a second clock and a second relay;
the second clock is connected to a normally open terminal of the first relay, wherein the second clock counts to a second period of time T2;
the second relay is controllable by the second clock, wherein the second relay is activated at the end of the period of time T2;
the sprinkler valve is further electrically connected to a second normally open terminal of the second relay;
the sprinkler valve controls the flow of water between the water line and a sequential valve; and
the sequential valve is connected to the first sprinkler line and the second sprinkler line, wherein the sequential valve provides the flow of water to the first sprinkler line during the first period of time T1, and the sequential valve provides the flow of water to the second sprinkler line after the second period of time T2.

12. The sprinkler system of claim 11, wherein the switch is attached to the sprinkler valve.

13. A method for expanding a sprinkler system, the method comprising:
electrically connecting a switch between a timer and a first sprinkler valve and between the timer and a second sprinkler valve;
providing a sprinkler valve signal to the switch;
providing the sprinkler valve signal to a clock in the switch;
counting a period of time T within the clock when the sprinkler valve signal is present;
sending a clock signal from the clock to a relay when the period of time T has ended; and
actuating the relay, thereby opening a normally closed circuit between the relay and the first sprinkler valve, and closing a normally open circuit between the relay and the second sprinkler valve.

14. The method of claim 13, wherein providing the sprinkler valve signal to a clock in the switch comprises providing the sprinkler valve signal to a rectifier and providing a rectified signal to the clock.

15. The method of claim 13, wherein providing the sprinkler valve signal to a clock in the switch comprises providing an Alternating Current (AC) sprinkler valve signal to an AC delay-on-make timer.

16. The method of claim 13, further including setting a variable resistance to set the period of time T.

17. A sprinkler system expander comprising:
an input sprinkler wire connected between a sprinkler timer and a switch;
a clock residing in the switch configured to receive power through the input sprinkler wire and to count a period of time T starting when power is provided on the input sprinkler wire;
a first output sprinkler wire;
a first electrical connection controlled by the clock and residing between the input sprinkler wire and the first output sprinkler wire, wherein the first electrical connection is closed while the clock is counting the period of time T and is open after the clock completes counting the period of time T;
a second output sprinkler wire; and
a second electrical connection controlled by the clock and residing between the input sprinkler wire and the second output sprinkler wire, wherein the second electrical connection is open while the clock is counting the period of time T and is closed after the clock completes counting the period of time T.

18. The system of claim 17, wherein the clock is an Alternating Current (AC) delay-on-make timer.

19. The system of claim 18, wherein a variable resistor is electrically connected to the AC delay-on-make timer to vary the period of time T.

20. A sprinkler system expander comprising:
an input sprinkler wire connected between a sprinkler timer and a switch;
an output sprinkler wire connected between the switch and a sprinkler valve;
a first clock residing in the switch and configured to receive power through the input sprinkler wire and to count a first period of time T1 starting when power is provided on the input sprinkler wire;
a first electrical connection controlled by the first clock and residing between the input sprinkler wire and the output sprinkler wire, wherein the first electrical connection is closed while the first clock is counting the period of time T1 and is open after the first clock completes counting the period of time T1;
a second electrical connection controlled by the first clock and residing between the input sprinkler wire and a second clock, wherein the second electrical connection is open while the first clock is counting the period of time T1 and is closed after the clock completes counting the period of time T1;
a third electrical connection controlled by the second clock and residing between the input sprinkler wire and the output sprinkler wire, wherein the third electrical connection is open while the second clock is counting a period of time T2 and is closed after the second clock completes counting the period of time T2; and
a sequential valve receiving a flow of water from the sprinkler valve.
